(19) United States
(12) Patent Application Publication
(10) Pub. No.: US 2016/0371799 A1
(43) Pub. Date: Dec. 22, 2016

(54) Travel Booking with Automatic Consumption of Loyalty Reward Points

(71) Applicant: Amgine Technologies (US), Inc., Austin, TX (US)

(72) Inventors: Harold Roy Miller, Toronto (CA); Jonathan David Miller, Toronto (CA); L. James Valverde, JR., Washington, DC (US)

(21) Appl. No.: 15/183,620

(22) Filed: Jun. 15, 2016

Related U.S. Application Data
(60) Provisional application No. 62/181,135, filed on Jun. 17, 2015.

(51) Int. Cl. G06Q 50/14; G06Q 30/02

(52) U.S. Cl. CPC G06Q 50/14; G06Q 30/0226

(57) ABSTRACT

A method for booking an itinerary using automatic consumption of loyalty reward points may commence with receiving loyalty point data associated with a customer. The loyalty point data may be associated with at least one loyalty program and loyalty reward points of the customer. The method may include receiving customer travel preferences and a request to schedule the itinerary using the loyalty reward points. Based on the loyalty point data, the at least one loyalty program may be accessed to determine an amount of the loyalty reward points and available loyalty reward offerings for the customer. The method may continue with searching for feasible itineraries for the customer based on the loyalty reward points, the available loyalty reward offerings, and the customer travel preferences. Upon selecting an itinerary from the feasible itineraries by the customer, the loyalty reward points may be consumed to book the selected itinerary.

### CROSS-REFERENCE TO RELATED APPLICATIONS

The present utility patent application is related to and claims the priority benefit under 35 U.S.C. 119(e) of U.S. provisional application No. 62/181,135, filed on Jun. 17, 2015, and titled “Travel Booking with Automatic Consumption of Loyalty Reward Points.” The disclosure of this related provisional application is incorporated herein by reference for all purposes to the extent that such subject matter is not inconsistent herewith or limiting hereof.

### TECHNICAL FIELD

The present disclosure relates generally to data processing and, more specifically, to methods and systems for booking an itinerary through automatic consumption of loyalty reward points.

### BACKGROUND

Many airlines, hotels, and other enterprises in travel and hospitality industries provide various loyalty programs to their customers. As a member of a loyalty program, a customer can receive loyalty reward points, rewards, and various other benefits associated with bookings. Acquired loyalty reward points can be redeemed for air travel and goods or services, or for increased benefits, such as upgrades, airport lounge access, or priority bookings. Thus, loyalty program members can benefit from obtaining free or discounted air tickets, hotel and cars bookings, and so forth.

However, the process of redeeming accumulated loyalty reward points can be complex and time-consuming. Additionally, some enterprises in travel and hospitality industries may set rules limiting a portion of a ticket price allowed to be paid by the loyalty reward points (e.g., when only thirty percent of the ticket price may be paid by the loyalty reward points, while seventy percent of the ticket price must be paid by cash). Vice versa, a partial payment of the ticket price, when a portion of the ticket price is paid by the loyalty reward points and another portion of the ticket price is paid by cash, may be not allowed. Furthermore, redemption of loyalty reward points for certain dates can be unavailable due to blackout or limited availability.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

According to one example embodiment of the disclosure, a method for booking an itinerary using automatic consumption of loyalty reward points is provided. The method may include receiving loyalty point data associated with a customer. The loyalty point data may be associated with at least one loyalty program. The at least one loyalty program may be associated with the loyalty reward points of the customer. Furthermore, the method may include receiving customer travel preferences. The method may continue with receiving a request to schedule the itinerary for the customer using the loyalty reward points associated with the at least one loyalty program. The method may include accessing, based on the loyalty point data, the at least one loyalty program to determine an amount of the loyalty reward points and available loyalty reward offerings for the customer. Furthermore, the method may include searching for at least one feasible itinerary for the customer based at least on the loyalty reward points, the available loyalty reward offerings, and the customer travel preferences. The method may further include presenting the at least one feasible itinerary to the customer for selection. The method may include identifying a selected itinerary upon receipt of the selection from the customer. Furthermore, the method may include consuming the loyalty reward points of the customer to book the selected itinerary.

According to another example embodiment of the disclosure, a system for booking an itinerary using automatic consumption of loyalty reward points is provided. The system may include a processor and a scheduler in communication with the processor. The processor may be operable to receive loyalty point data associated with a customer. The loyalty point data may be associated with at least one loyalty program. The at least one loyalty program may be associated with the loyalty reward points of the customer. The processor may be operable to receive customer travel preferences and a request to schedule the itinerary for the customer using the loyalty reward points associated with the at least one loyalty program. The scheduler may be operable to search for the at least one feasible itinerary for the customer based at least on the loyalty reward points, the available loyalty reward offerings, and the customer travel preferences. The processor may be further operable to access, based on the loyalty point data, the at least one loyalty program to determine an amount of the loyalty reward points and available loyalty reward offerings for the customer. Furthermore, the processor may be operable to present at least one feasible itinerary to the customer for selection. Upon receiving of the selection from the customer, a selected itinerary may be identified. The processor may be further operable to consume the loyalty reward points to book the selected itinerary.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements.

FIG. 1 illustrates an environment within which systems and methods for booking an itinerary using automatic consumption of loyalty reward points can be implemented.

FIG. 2 a block diagram showing various modules of a system for booking an itinerary using automatic consumption of loyalty reward points.

FIG. 3 is a process flow diagram showing a method for booking an itinerary using automatic consumption of loyalty reward points.

FIG. 4 is a schematic diagram illustrating scheduling of an itinerary for a customer.

FIG. 5 is a schematic diagram illustrating redemption of loyalty reward points for booking an itinerary selected by a customer.

FIG. 6 shows a diagrammatic representation of a computing device for a machine in the exemplary electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

Loyalty programs in travel and hospitality industries provide savings opportunities for customers. A customer can get a discount on a purchase or an allotment of loyalty reward points that can be used for future purchases. To facilitate loyalty reward point redemption, a system for booking an itinerary using automatic consumption of loyalty reward points can assist the customer with searching, selecting, and buying travel itineraries using loyalty reward points. The customer can provide data concerning a loyalty program in which the customer participates, travel preferences, and specific data for a requested travel itinerary. The system for booking an itinerary using automatic consumption of loyalty reward points can receive such data from the customer and search for feasible itineraries for the customer based on available loyalty reward offerings of the loyalty program. The feasible itineraries can be presented to the customer. The customer can select one of the feasible itineraries. The system for booking an itinerary using automatic consumption of loyalty reward points can receive the selection from the customer and book the selected itinerary by redeeming the loyalty reward points of the customer.

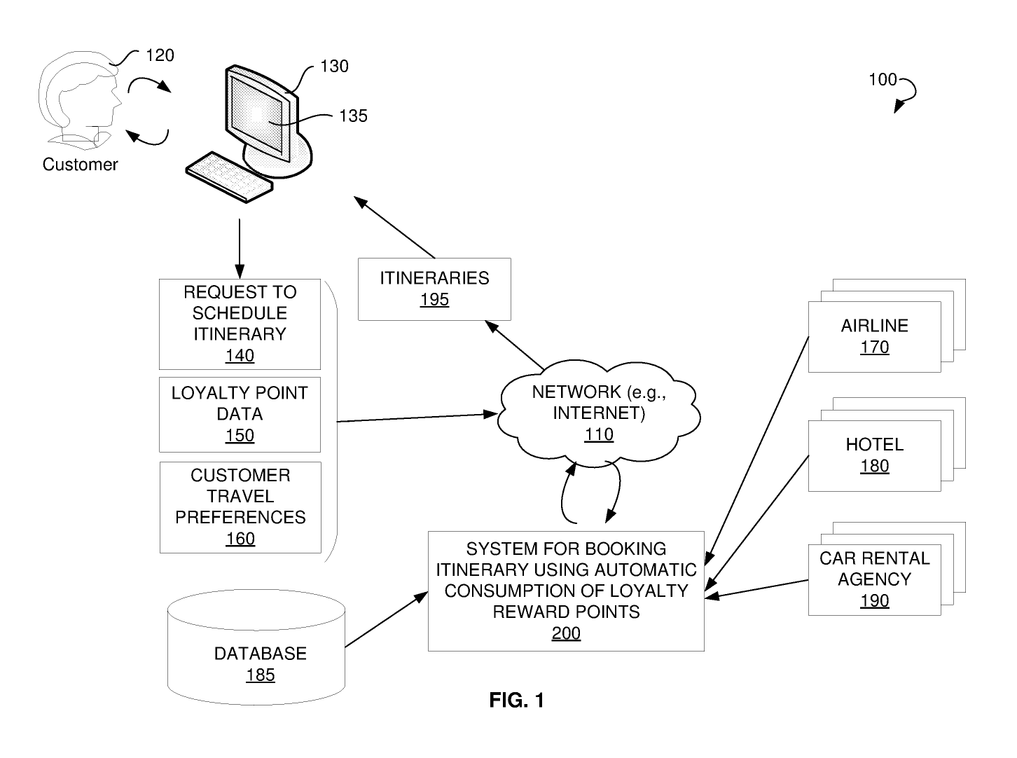

FIG. 1 illustrates an environment 100 within which systems and methods for booking an itinerary using automatic consumption of loyalty reward points can be implemented. The environment 100 may include a system 200 for booking an itinerary using automatic consumption of loyalty reward points. A customer 120 may communicate with the system 200 via a client application (not shown) available through a user device 130.

The system 200 may receive a request 140 to schedule an itinerary from the customer 120. The request 140 may include travel-related information, such as a city of departure, a city of destination, departure date, return date, a class of travel, and so forth. The request 140 may be received, for example, via a user interface 135 displayed on the user device 130. The request 140 may be provided as a natural language input by the customer 120 via a voice command. Based on the voice command, text data may be obtained by speech-to-text conversion of the natural language input or an oral exchange with the customer 120, or otherwise. In some embodiments, to motivate the customer 120 to provide the request 140, the customer 120 may be asked, orally, one or more motivating questions.

The request 140 may be transmitted to the system 200 via a network 110. The network 110 may include the Internet or any other network capable of communicating data between devices. Suitable networks may include or interface with any one or more of, for instance, a local intranet, a Personal Area Network, a Local Area Network (LAN), a Wide Area Network (WAN), a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a Small Computer Systems Interface connection, a Universal Serial Bus connection or other wired or wireless, digital or analog interface or connection, mesh or Digi® networking. The network 110 may be a network of data processing nodes that are interconnected for the purpose of data communication. The network 110 may include any suitable number and type of devices (e.g., routers and switches) for forwarding commands, content, and/or web object requests from each user and responses back to the users.

The user device 130, in some example embodiments, may include a Graphical User Interface for displaying the user interface 135 associated with the system 200. The user device 130 may include a mobile telephone, a personal computer (PC), a laptop, a smart phone, a tablet PC, and so forth. The system 200 may include a server-based distributed application; thus, the system 200 may include a central component residing on a server and one or more client applications residing on one or more user devices, such as the user device 130, and communicating with the central component via the network 110.

The system 200 may further receive loyalty point data 150 associated with the customer 120 and customer travel preferences 160. Using the loyalty point data 150, the system 200 can access one or more loyalty programs associated with the customer 120 to receive loyalty reward offerings available for the customer 120, loyalty point amounts, special loyalty program rules, and so forth. To access the loyalty programs, the system 200 can communicate with one or more airlines 170, hotels 180, car rental agencies 190, and so forth.

The system 200 may analyze travel itineraries available, for example, from a database 185 based on the customer travel preferences 160 and the request 140 and may select itineraries 195 in accordance with available loyalty reward offerings for the customer 120. The itineraries 195 may be presented to the customer 120 using the user device 130, for example, via the client application, a web resource, an e-mail, and so forth. The system 200 may book the one or more of the itineraries 195 using the loyalty reward points of the customer.

The customer 120 thus may save time that otherwise may be wasted by browsing through various web resources, searching for loyalty reward offerings, and scheduling travel itineraries based on data from various sources.

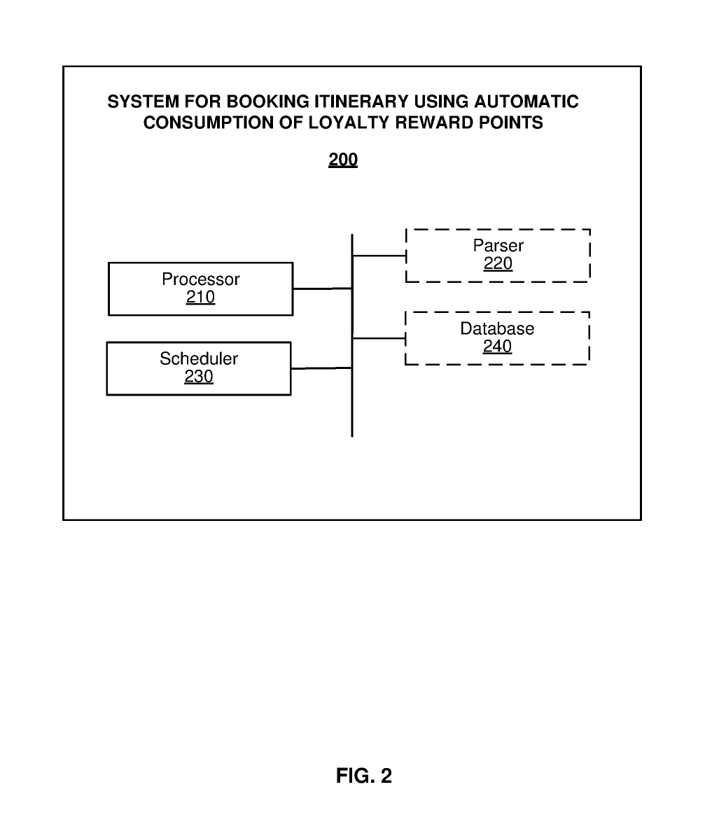

FIG. 2 shows a block diagram illustrating various modules of a system for booking an itinerary using automatic consumption of loyalty reward points, according to an example embodiment. The system 200 may include a processor 210, an optional parser 220, a scheduler 230, and optionally a database 240. The processor 210 may include a programmable processor, such as a microcontroller, a central processing unit (CPU), and so forth. In other embodiments, the processor 210 may include an application-specific integrated circuit or programmable logic array, such as a field programmable gate array, designed to implement the functions performed by the system 200.

The processor 210 may be operable to receive loyalty point data associated with a customer. More specifically, the loyalty point data may be associated with at least one loyalty program in which the customer may participate. Based on participation in the at least one loyalty program, the customer may have loyalty reward points associated with the at least one loyalty program. Information related to the at least one loyalty program and the loyalty point data may be stored in the database 240.

In an example embodiment, the customer may be registered in the at least one loyalty program and may have a customer account associated with the at least one loyalty program. Information related to the loyalty reward points of the customer may be stored in the customer account.

The processor 210 may be further operable to receive a request to schedule the itinerary for the customer using the loyalty reward points associated with the at least one loyalty program. The customer may provide the request using a user device. In an example embodiment, the request to schedule the itinerary may be provided using a voice command by a natural language, a typed text, and so forth. The request to schedule the itinerary may include at least travel-related information. Upon receipt of the request, the parser 220 of the system 200 may parse the request by processing the natural language associated with the request. Upon the parsing, the travel-related information may be extracted from the request. The travel-related information may include, for example, a departure city, a destination city, a departure date, a return date, a class of travel, time of travel, a hotel, a car reservation, and so forth.

The processor 210 may be further operable to receive customer travel preferences. In an example embodiment, the customer travel preferences may be obtained from the customer account. The customer may provide the customer travel preferences upon registering the customer account in the at least one loyalty program. In an example embodiment, the customer travel preferences may be selected based on previously booked itineraries of the customer. In a further example embodiment, the customer travel preferences may be provided by the customer along with providing of the request to schedule the itinerary. The customer travel preferences may include one or more of the following: a preferred vendor, an airline, a hotel chain, and a type of hotel roomdd.

Based on the loyalty point data, the processor 210 may access the at least one loyalty program to determine an amount of the loyalty reward points and available loyalty reward offerings for the customer. In an example embodiment, the at least one loyalty program may be associated with a plurality of airlines, hotels, car rental agencies, and so forth, which may provide loyalty reward offerings for the customer. Therefore, accessing the at least one loyalty program may include communicating of the processor 210 with one or more of the airlines, hotels, car rental agencies, and other organizations providing loyalty reward offerings. In an example embodiment, the processor 210 may use the travel-related information to select the airlines, the hotels, and the car rental agencies for communication. For example, if a destination city specified by the customer in the request is New York, the processor 210 may communicate hotels located in New York, but not all hotels providing loyalty reward offerings.

The scheduler 230 may be operable to search for the at least one feasible itinerary for the customer based at least on the loyalty reward points, the available loyalty reward offerings, and the customer travel preferences. Upon the search, the processor 210 may present the at least one feasible itinerary to the customer for selection.

Optionally, upon the search, the processor 210 may be operable to rank one or more of the at least one feasible itinerary based on the customer travel preferences. In a further example embodiment, the processor 210 may be operable to rank the one or more of the at least one feasible itinerary based on a consumption of the loyalty reward points. The consumption may be determined based on the available loyalty reward offerings. For example, itineraries for which a larger amount of loyalty reward points is needed may be presented first, followed by itineraries for which a lesser amount of loyalty reward points is needed.

In a further example embodiment, the at least one feasible itinerary may be presented to the customer in a form of a plurality of legs of a travel associated with the at least one feasible itinerary. Each of the legs of a travel may be a portion of the at least one feasible itinerary. Furthermore, the at least one feasible itinerary may be presented in a form of a plurality of items associated with the at least one feasible itinerary. The items may include one or more of the following: a hotel, an airline, departure time, arrival time, a departure airport, an arrival airport, time of a flight, connection time between flights, and a number of flights connections.

Upon receiving of the selection from the customer, the processor 210 may identify a selected itinerary. Based on identification of the selected itinerary, the processor 210 may consume the loyalty reward points to book the selected itinerary. More specifically, the processor 210 may use the loyalty reward points to book the selected itinerary. Therefore, an amount of the loyalty reward points on the customer account in the loyalty program may be reduced for the amount of the loyalty reward points needed to book the selected itinerary. In an example embodiment, the processor 210 may calculate updated loyalty reward points based on the consumed loyalty reward points and update the loyalty point data in the database 240.

Additionally, the customer may provide a specifying request along with the selection of the itinerary. The specifying request may be associated with specifying one or more of the items of the selected itinerary. The specifying request may include a replacement item being an item with which the customer may want to replace one of the items of the selected itinerary. Upon receipt of the specifying request from the customer, the processor 210 may overwrite the item of the selected itinerary with the replacement item. For example, the customer may provide the replacement item by selecting a hotel different from a hotel of the selected itinerary. In response to receiving of the replacement item, the processor 210 may replace the hotel of the selected itinerary with the hotel selected by the customer.

In an example embodiment, upon identification of the selected itinerary, the processor 210 may receive a cash payment request from the customer. With the cash payment request, the customer may request for paying by cash, instead of the loyalty reward points, for one or more items of the selected itinerary. The cash payment request may include the selection of the item for which the customer wants to pay by cash. Based on the cash payment request, the processor may charge the customer for the selected item. The loyalty reward points may be consumed for the rest of the items of the selected itinerary.

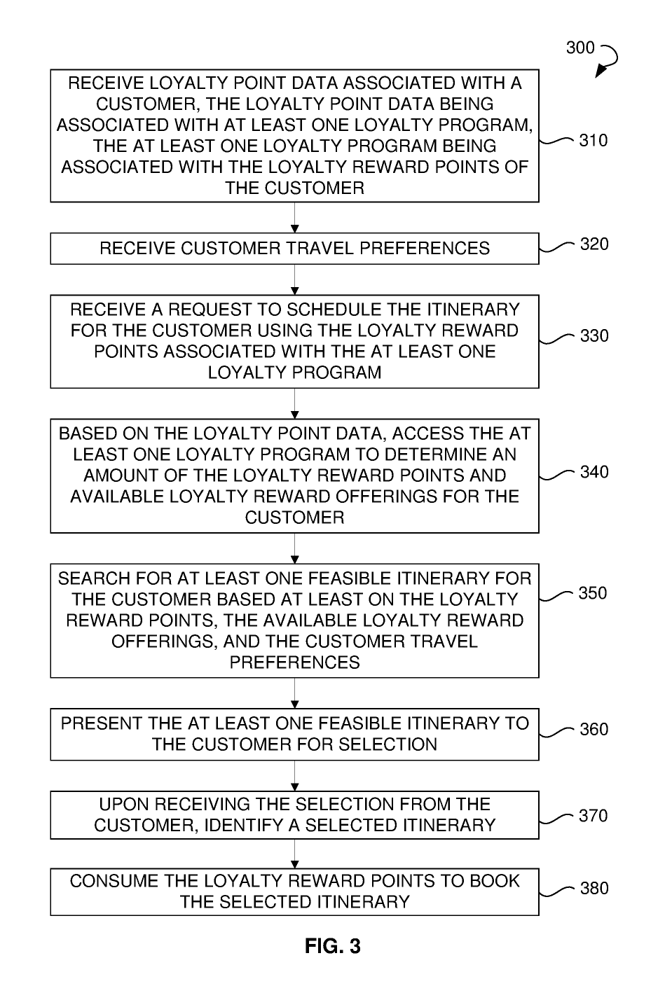

FIG. 3 is a process flow diagram showing a method 300 for booking an itinerary using automatic consumption of loyalty reward points within the environment described with reference to FIG. 1. The method 300 may commence with receiving loyalty point data associated with a customer at operation 310. The loyalty point data may be associated with one or more loyalty programs. Therefore, the loyalty point data may provide access to the loyalty programs associated with the customer. More specifically, the loyalty program may be associated with the loyalty reward points of the customer. The method 300 may further include receiving customer travel preferences at operation 320. The customer travel preferences may include a preferred vendor, an airline, a hotel chain, a flight class, and so forth.

When the customer decides to purchase a travel, the customer may send a request to schedule an itinerary for the customer using the loyalty reward points associated with the loyalty program. The request to schedule the itinerary for the customer may be received at operation 330. Based on the loyalty point data, the loyalty program may be accessed at operation 340 to determine an amount of the loyalty reward points and available loyalty reward offerings for the customer.

Upon accessing the loyalty program, a search for feasible itineraries for the customer may be performed at operation 350. The search may be based at least on the loyalty reward points, the available loyalty reward offerings, and the customer travel preferences. The search may result in generating a plurality of feasible itineraries for which the loyalty reward points of the customer can be employed.

Upon the search, one or more feasible itineraries may be presented to the customer for selection at operation 360. In response to the presenting of the one or more feasible itineraries, the customer may select one of the feasible itineraries. Upon receipt of the selection from the customer, a selected itinerary can be identified at operation 370. Upon identifying the selected itinerary, operation 380 may be performed at which the loyalty reward points may be consumed to book the selected itinerary. The method 300 may further include calculating, based on the consumed loyalty reward points, an updated loyalty reward points and updating the loyalty point data by storing data related to the updated loyalty reward points into the database.

In an example embodiment, upon the search, the feasible itineraries can be ranked based on the customer travel preferences. In a further example embodiment, the feasible itineraries can be ranked based on a consumption of the loyalty reward points. The consumption of the loyalty reward points may be determined based on the available loyalty reward offerings.

In some embodiments, each leg of a travel in the presented feasible itineraries can be presented separately. Each of the legs may represent a portion of the feasible itinerary. Thus, the customer can combine legs of the travel from different feasible itineraries.

Additionally, the feasible itinerary may be presented in a form of a plurality of items associated with the feasible itinerary, such as a hotel, an airline, departure time, arrival time, a departure airport, an arrival airport, time of a flight, connection time between flights, a number of flight connections, and so forth. The method 300 may further include receiving a specifying request from the customer to specify one or more items of the selected itinerary. The customer may select a replacement item to be used instead of one or more items of the selected itinerary. Based on the specifying request, the one or more items may be overwritten with the replacement item. For example, the customer can specify an airline or a hotel of the feasible itinerary.

In some embodiments, the customer may be further provided with an option to specify a type of room in a hotel. Utilizing this option may be associated with using additional customer loyalty reward points. On his discretion, the customer may also choose to pay cash instead of loyalty reward points for any item in the itinerary. More specifically, the method 300 may include receiving a cash payment request from the customer. With the cash payment request, the customer may request to pay by cash for one or more items of the selected itinerary. Based on the cash payment request, the customer may be charged for the one or more items.

Additionally, the customer may be provided with an option to eliminate blackout dates for flights and hotel reservations for loyalty reward points. A number of extra points needed to book an itinerary on blackout days can be predetermined. For example, typically, a Toronto to Seattle flight costs 30,000 loyalty reward points. An option may be provided to book the flight for 40,000 loyalty reward points with no blackout dates. Thus, a 30% penalty may save time spent looking for alternative flights to avoid blackout days.

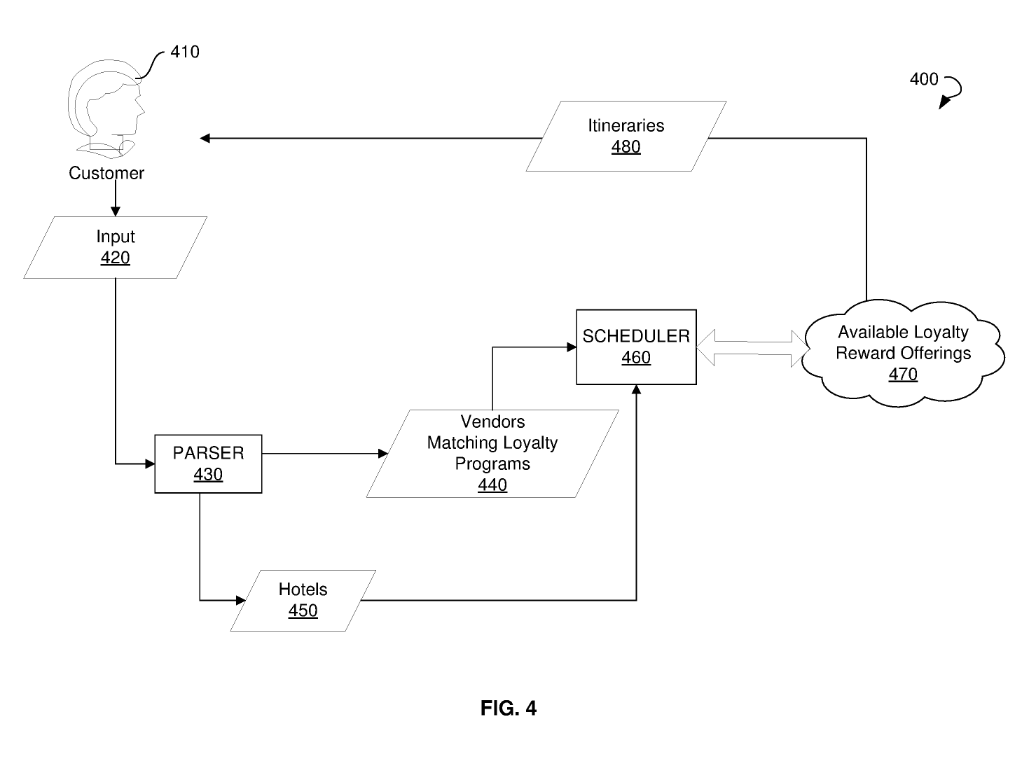

FIG. 4 is a schematic diagram 400 showing scheduling an itinerary for a customer, in accordance with some embodiments. The customer 410 may request for scheduling an itinerary by providing an input 420. The input 420 can be parsed by a parser 430 to extract travel characteristics. The travel characteristics may be related to vendors 440 matching loyalty programs, preferred hotels 450, and so forth. A scheduler 460 may include a search engine and may perform a search among available loyalty reward offerings 470 using the travel characteristics, such as the vendors 440 matching loyalty programs and the hotels 450, and data related to the loyalty reward points obtained from a database (not shown). Based on the search, itineraries 480 matching the input 420 may be generated and provided to the customer 410.

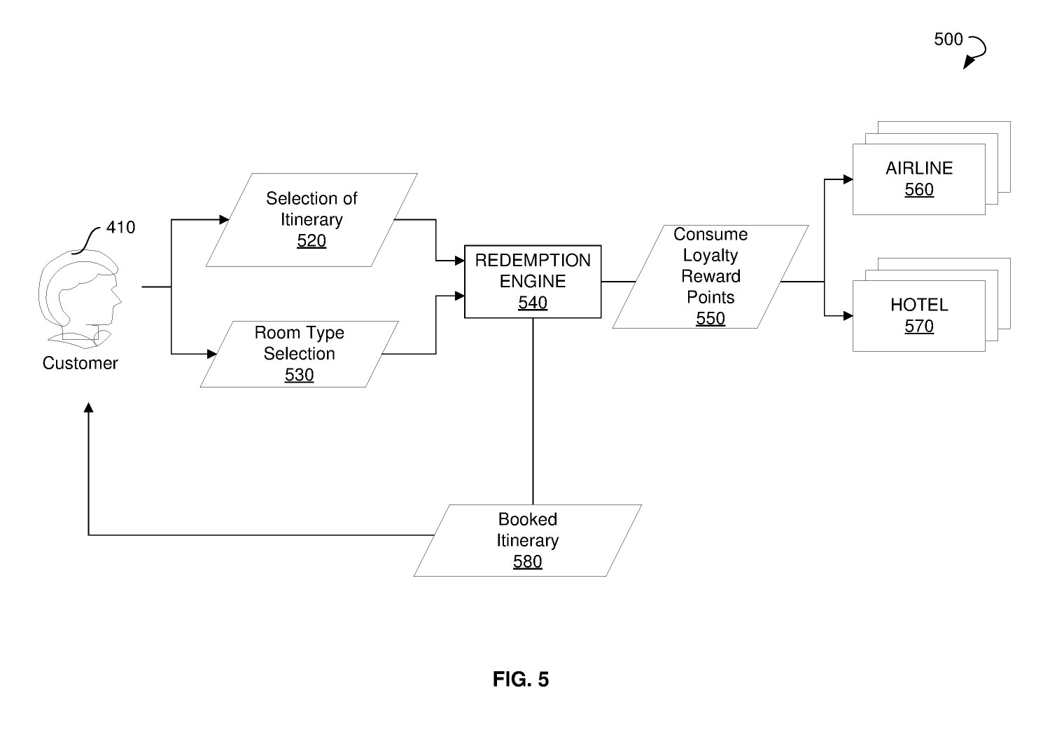

FIG. 5 is a schematic diagram 500 showing redemption of loyalty reward points for booking an itinerary selected by a customer, in accordance with some example embodiments. After the customer 410 receives itineraries, makes adjustments and corrections, and selects one of the proposed itineraries, the selections of the customer 410, such a selection 520 of an itinerary and a selection 530 of a room type, may be transmitted to a redemption engine 540. In an example embodiment, the redemption engine 540 may include a processor shown as a processor 210 on FIG. 2. At step 550, the redemption engine 540 may book the selected itinerary from airlines 560, hotels 570, and the like by automatically consuming the loyalty reward points of the customer 410. The booked itinerary 580 may be then provided to the customer 410.

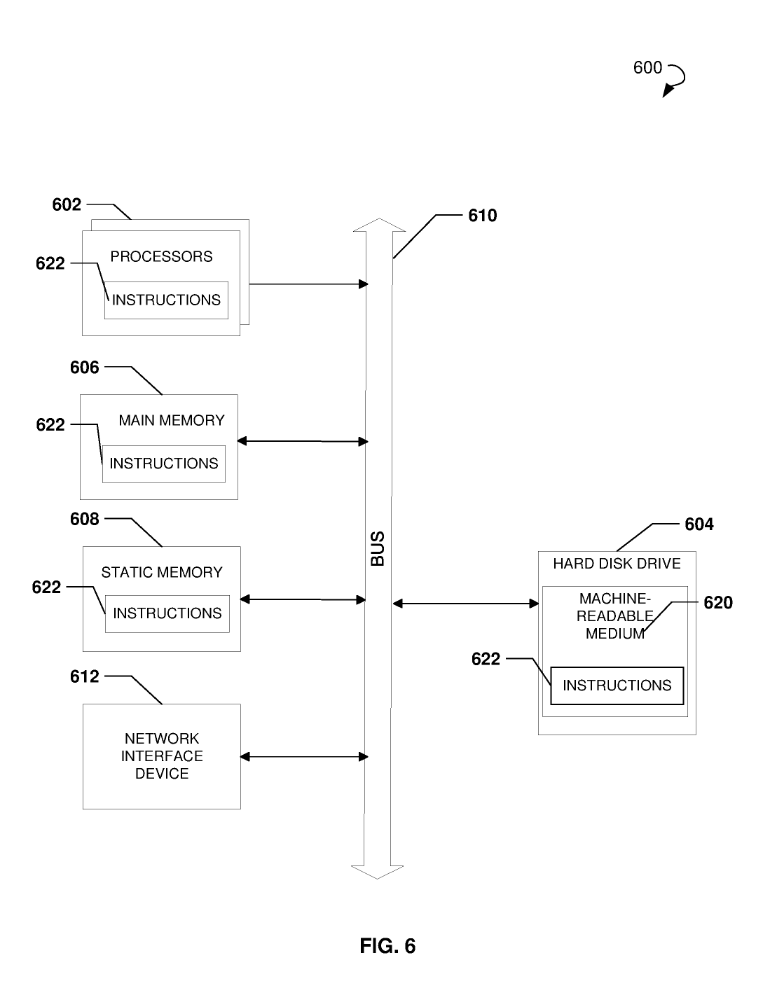

FIG. 6 shows a diagrammatic representation of a computing device for a machine in the exemplary electronic form of a computer system 600, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a PC, a tablet PC, a set-top box, a cellular telephone, a digital camera, a portable music player (e.g., a portable hard drive audio device, such as an Moving Picture Experts Group Audio Layer 3 player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 600 includes a processor or multiple processors 602, a hard disk drive 604, a main memory 606, and a static memory 608, which communicate with each other via a bus 610. The computer system 600 may also include a network interface device 612. The hard disk drive 604 may include a computer-readable medium 620, which stores one or more sets of instructions 622 embodying or utilized by any one or more of the methodologies or functions described herein. The instructions 622 can also reside, completely or at least partially, within the main memory 606, the static memory 608, and/or within the processors 602 during execution thereof by the computer system 600. The main memory 606 and the processors 602 also constitute machine-readable media.

While the computer-readable medium 620 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, Random Access Memory (RAM), Read-Only Memory (ROM), and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems.

In some embodiments, the computer system 600 may be implemented as a cloud-based computing environment, such as a virtual machine operating within a computing cloud. In other embodiments, the computer system 600 may itself include a cloud-based computing environment, where the functionalities of the computer system 600 are executed in a distributed fashion. Thus, the computer system 600, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners, or such systems may be accessible to outside users who deploy applications within the computing infrastructure to obtain the benefit of large computational or storage resources.

The cloud may be formed, for example, by a network of web servers that comprise a plurality of computing devices, such as a client device, with each server (or at least a plurality thereof) providing processor and/or storage resources. These servers may manage workloads provided by multiple users (e.g., cloud resource consumers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire, and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a Compact Disc Read-Only Memory disk, digital video disk, any other optical medium, any other physical medium with patterns of marks or holes, a RAM, a Programmable Read-Only Memory, an Erasable Programmable Read-Only Memory (EPROM), an Electrically Erasable Programmable Read-Only Memory, a FlashEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

The corresponding structures, materials, acts, and equivalents of all means or steps plus function elements in the claims below are intended to include any structure, material, or act for performing the function in combination with other claimed elements as specifically claimed. The description of the present technology has been presented for purposes of illustration and description, but is not intended to be exhaustive or limited to the disclosure. Many modifications and variations will be apparent to those of ordinary skill in the art without departing from the scope and spirit of the disclosure. Exemplary embodiments were chosen and described in order to best explain the principles of the present technology and its practical application, and to enable others of ordinary skill in the art to understand the disclosure for various embodiments with various modifications as are suited to the particular use contemplated.

Aspects of the present technology are described above with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Thus, computer-implemented methods and systems for booking an itinerary using automatic consumption of loyalty reward points are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

What is claimed is:

1. A system for booking an itinerary using automatic consumption of loyalty reward points, the system comprising:
a processor operable to:
receive loyalty point data associated with a customer, the loyalty point data being associated with at least one loyalty program, the at least one loyalty program being associated with the loyalty reward points of the customer;
receive customer travel preferences;
receive a request to schedule an itinerary for the customer using the loyalty reward points associated with the at least one loyalty program;
based on the loyalty point data, access the at least one loyalty program to determine an amount of the loyalty reward points and available loyalty reward offerings for the customer;
present at least one feasible itinerary to the customer for selection;
upon receiving of the selection from the customer, identify a selected itinerary; and
consume the loyalty reward points to book the selected itinerary; and
a scheduler in communication with the processor and operable to:
search for the at least one feasible itinerary for the customer based at least on the loyalty reward points, the available loyalty reward offerings, and the customer travel preferences.

2. The system of claim 1, wherein the customer travel preferences include one or more of the following: a preferred vendor, an airline, a hotel chain, and a type of room.

3. The system of claim 1, wherein the processor is further operable to:
based on the searching, rank one or more of the at least one feasible itinerary based on the customer travel preferences.

4. The system of claim 1, wherein the processor is further operable to:
based on the searching, rank one or more of the at least one feasible itinerary based on a consumption of the loyalty reward points, the consumption being based on the available loyalty reward offerings.

5. The system of claim 1, wherein the presenting of the at least one feasible itinerary includes presenting a plurality of legs of a travel associated with the at least one feasible itinerary, each of the plurality of legs of a travel being a portion of the at least one feasible itinerary.

6. The system of claim 1, wherein the presenting of the at least one feasible itinerary includes presenting a plurality of items associated with the at least one feasible itinerary, the plurality of items including one or more of the following: a hotel, an airline, departure time, arrival time, a departure airport, an arrival airport, time of a flight, connection time between flights, and a number of flight connections.

7. The system of claim 6, wherein the processor is further operable to:
upon identifying the selected itinerary, receive a specifying request from the customer, the specifying request being associated with specifying one or more of the plurality of items associated with the selected itinerary, the specifying request including at least a replacement item; and
based on the specifying request, overwrite the one or more of the plurality of items with the replacement item.

8. The system of claim 6, wherein the processor is further operable to:
upon identifying the selected itinerary, receive a cash payment request from the customer, the cash payment request being associated with paying by cash for one or more of the plurality of items associated with the selected itinerary; and
based on the cash payment request, charge for the one or more of the plurality of items.

9. The system of claim 1, wherein the processor is further operable to:
based on the consuming, calculate an updated amount of loyalty reward points; and
based on the calculating, update the loyalty point data.

10. The system of claim 1, wherein the request to schedule the itinerary includes at least travel-related information, the travel-related information including one or more of the following: a departure city, a destination city, a departure date, a return date, and a class of travel.

11. The system of claim 10, wherein the accessing of the at least one loyalty program includes communicating with one or more of the following: airlines, hotels, and car rental agencies, wherein the airlines, the hotels, and the car rental agencies are selected based on the travel-related information.

12. A method for booking an itinerary using automatic consumption of loyalty reward points, the method comprising:
receiving, by a processor, loyalty point data associated with a customer, the loyalty point data being associated with at least one loyalty program, the at least one loyalty program being associated with the loyalty reward points of the customer;
receiving, by the processor, customer travel preferences;
receiving, by the processor, a request to schedule an itinerary for the customer using the loyalty reward points associated with the at least one loyalty program;
based on the loyalty point data, accessing, by the processor, the at least one loyalty program to determine an amount of the loyalty reward points and available loyalty reward offerings for the customer;
searching, by a scheduler, for at least one feasible itinerary for the customer based at least on the loyalty reward points, the available loyalty reward offerings, and the customer travel preferences;
presenting, by the processor, the at least one feasible itinerary to the customer for selection;
upon receiving the selection from the customer, identifying, by the processor, a selected itinerary; and
consuming, by the processor, the loyalty reward points to book the selected itinerary.

13. The method of claim 12, further comprising ranking, by the processor, based on the searching, one or more of the at least one feasible itinerary based on the customer travel preferences.

14. The method of claim 12, further comprising ranking, by the processor, based on the searching, one or more of the at least one feasible itinerary based on a consumption of the loyalty reward points, the consumption being based on the available loyalty reward offerings.

15. The method of claim 12, wherein the presenting of the at least one feasible itinerary includes presenting a plurality of legs of a travel associated with the at least one feasible itinerary, each of the plurality of legs of a travel being a portion of the at least one feasible itinerary.

16. The method of claim 12, wherein the presenting of the at least one feasible itinerary includes presenting a plurality of items associated with the at least one feasible itinerary, the plurality of items including one or more of the following: a hotel, an airline, departure time, arrival time, a departure airport, an arrival airport, time of a flight, connection time between flights, and a number of flight connections.

17. The method of claim 16, further comprising:
upon identifying the selected itinerary, receiving, by the processor, a specifying request from the customer, the specifying request being associated with specifying one or more of the plurality of items associated with the selected itinerary, the specifying request including at least a replacement item; and
based on the specifying request, overwriting, by the processor, the one or more of the plurality of items with the replacement item.

18. The method of claim 16, further comprising:
upon identifying the selected itinerary, receiving, by the processor, a cash payment request from the customer, the cash payment request being associated with paying by cash for one or more of the plurality of items associated with the selected itinerary; and
based on the cash payment request, charging, by the processor, for the one or more of the plurality of items.

19. The method of claim 12, further comprising:
based on the consuming, calculating, by the processor, an updated loyalty reward points; and
based on the calculating, updating, by the processor, the loyalty point data.

20. A system for booking an itinerary using automatic consumption of loyalty reward points, the system comprising:
a processor operable to:
receive loyalty point data associated with a customer, the loyalty point data being associated with at least one loyalty program, the at least one loyalty program being associated with the loyalty reward points of the customer;
receive customer travel preferences;
receive a request to schedule an itinerary for the customer using the loyalty reward points associated with the at least one loyalty program;
based on the loyalty point data, access the at least one loyalty program to determine an amount of the loyalty reward points and available loyalty reward offerings for the customer;
present at least one feasible itinerary to the customer for selection;
upon receiving the selection from the customer, identify a selected itinerary;
consume the loyalty reward points to book the selected itinerary;
upon identifying the selected itinerary, receive a specifying request from the customer, the specifying request being associated with specifying one or more of a plurality of items associated with the selected itinerary, the specifying request including at least a replacement item, the plurality of items including one or more of the following: a hotel, an airline, departure time, arrival time, a departure airport, an arrival airport, time of a flight, connection time between flights, and a number of flight connections;
based on the specifying request, overwrite the one or more of the plurality of items with the replacement item;
upon identifying the selected itinerary, receive a cash payment request from the customer, the cash payment request being associated with paying by cash for one or more of the plurality of items associated with the selected itinerary; and
based on the cash payment request, charge for the one or more of the plurality of items; and
a scheduler in communication with the processor and operable to:
search for the at least one feasible itinerary for the customer based on the loyalty reward points, the available loyalty reward offerings, and the customer travel preferences.
